(19) United States
(12) Patent Application Publication
(10) Pub. No.: US 2018/0357238 A1
(43) Pub. Date: Dec. 13, 2018

(54) PROVIDING INFORMATION BASED ON INTENT

(71) Applicant: Google Inc., Mountain View, CA (US)

(72) Inventors: Mathew Cowan, New York, NY (US); Christopher Pedregal, New York, NY (US)

(21) Appl. No.: 13/929,461

(22) Filed: Jun. 27, 2013

Related U.S. Application Data
(60) Provisional application No. 61/733,105, filed on Dec. 4, 2012.

(51) Int. Cl. G06F 17/30

(52) U.S. Cl. CPC G06F 17/3053

(57) ABSTRACT

A system may identify one or more actions performed by a user to satisfy an intent for information regarding an entity; and determine a correlation score for the one or more actions. The correlation score may indicate a level of correlation between the one or more actions and satisfying the intent for the information regarding the entity. The system may determine that the correlation score satisfies a first threshold; obtain information identifying one or more changes associated with the entity; and determine a change score for the one or more changes. The change score may indicate a level of change that is associated with the entity. The system may determine that the change score satisfies a second threshold; and provide the information identifying the one or more changes to the user based on the correlation score satisfying the first threshold and the change score satisfying the second threshold.

### RELATED APPLICATION

This application is a non-provisional of U.S. Provisional Application No. 61/733,105, filed Dec. 4, 2012, the contents of which are incorporated herein by reference.

### BACKGROUND

This specification relates to providing information.

User devices, e.g., cell phones, tablets, personal assistant devices, computers, etc., provide users with information. Users can request specific information that is of interest to the users. For example, user devices can provide users with contact information, upcoming calendar events, traffic information, weather information, as well as any Internet accessible information requested by the user. User devices also provide notifications to users. For example, when a cell phone receives a call, the cell phone may provide a visual notification, e.g., a screen may display call information, an audible notification, e.g., a speaker may generate a ring tone, and/or a sensory notification, e.g., a motor causing vibrations. The user experience of a user device can depend on its ability to provide helpful notifications to the user.

### SUMMARY

This specification describes technologies relating to providing information based on intent.

According to some possible implementations, a computer-implemented method may include identifying one or more actions performed by a user to satisfy an intent for information regarding an entity; determining a correlation score for the one or more actions, where the correlation score may indicate a level of correlation between the one or more actions and satisfying the intent for the information regarding the entity; determining that the correlation score satisfies a first threshold; obtaining information describing one or more changes associated with the entity; determining a change score for the one or more changes, where the change score may indicate a level of change that is associated with the entity; determining that the change score satisfies a second threshold; and providing the information describing the one or more changes to the user based on the correlation score satisfying the first threshold and the change score satisfying the second threshold.

According to some possible implementations, providing the information to the user may include providing one or more links at a client device associated with the user, where the one or more links may reference one or more applications from which the intent for the information regarding the entity can be satisfied, where the method may further include receiving a selection of one of the one or more links from the user; and causing, based on the selection of the one of the one or more links, the client device to execute one of the one or more applications, where the one of the one or more applications may permit the intent for the information regarding the entity to be satisfied.

According to some possible implementations, providing the information to the user may include providing one or more links at a client device associated with the user, where the one or more links may reference one or more webpages from which the intent for the information regarding the entity can be satisfied, where the method may further include receiving a selection of one of the one or more links from the user; and causing, based on the selection of the one of the one or more links, the client device to execute a web browser which displays a webpage of the one or more webpages, where the webpage may permit the intent for the information regarding the entity to be satisfied.

According to some possible implementations, the user is a first user, where determining the correlation score for the one or more actions may include obtaining data, where the data may identify a set of instances of a set of second users satisfying the intent for the information regarding the entity, where the data, which identifies a particular instance, of the set of instances, of a second user, of the set of second users, satisfying the intent for the information regarding the entity, may identify one or more candidate actions performed by the second user prior to the second user satisfying the intent for the information regarding the entity; and determining the correlation score for the one or more actions from the data identifying the set of instances of the set of second users performing the one or more actions.

According to some possible implementations, determining the correlation score for the one or more actions may include determining the correlation score based on a number of the set of instances, identified by the data, of the second users performing the one or more actions.

According to some possible implementations, determining the correlation score for the one or more actions may include matching the one or more actions with particular actions relating to the intent for the information regarding the entity, where the particular actions may be associated with satisfying the intent for the information regarding the entity; and determining the correlation score for the one or more actions based on a number of the one or more actions that match the particular actions.

According to some possible implementations, determining the change score for the one or more changes may include quantifying the one or more changes; and determining the change score based on quantifying the one or more changes.

According to some possible implementations, a system may include one or more computers to: identify one or more actions performed by a user to satisfy an intent for information regarding an entity; determine a correlation score for the one or more actions, where the correlation score may indicate a level of correlation between the one or more actions and satisfying the intent for the information regarding the entity; determine that the correlation score satisfies a first threshold; obtain information identifying one or more changes associated with the entity; determine a change score for the one or more changes, where the change score may indicate a level of change that is associated with the entity; determine that the change score satisfies a second threshold; and provide the information identifying the one or more changes to the user based on the correlation score satisfying the first threshold and the change score satisfying the second threshold.

According to some possible implementations, the one or more computers, when providing the information to the user, may provide one or more links at a client device associated with the user, where the one or more links referencing one or more applications from which the intent for the information regarding the entity can be satisfied, where the one or more computers may further receive a selection of one of the one or more links from the user; and cause, based on the selection of the one of the one or more links, the client device to execute one of the one or more applications, where the one of the one or more applications may permit the intent for the information regarding the entity to be satisfied.

According to some possible implementations, the one or more computers, when providing the information to the user, may provide one or more links at a client device associated with the user, where the one or more links may reference one or more webpages from which the intent for the information regarding the entity can be satisfied, where the one or more computers may further receive a selection of one of the one or more links from the user; and cause, based on the selection of the one of the one or more links, the client device to execute a web browser which displays a webpage of the one or more webpages, and where the webpage may permit the intent for the information regarding the entity to be satisfied.

According to some possible implementations, the user is a first user, where the one or more computers, when determining the correlation score for the one or more actions, may obtain data, where the data may identify a set of instances of a set of second users satisfying the intent for the information regarding the entity, and where the data, which identifies a particular instance, of the set of instances, of a second user, of the set of second users, satisfying the intent for the information regarding the entity, may identify one or more candidate actions performed by the second user prior to the second user satisfying the intent for the information regarding the entity; and determine the correlation score for the one or more actions based on the data identifying the set of instances of the set of second users performing the one or more actions.

According to some possible implementations, the one or more computers, when determining the correlation score, may determine the correlation score based on a number of the set of instances, identified by the data, of the second users performing the one or more actions.

According to some possible implementations, the one or more computers, when determining the correlation score for the one or more actions, may match the one or more actions with particular actions relating to the intent for the information regarding the entity, where the particular actions may be associated with satisfying the intent for the information regarding the entity; and determine the correlation score for the one or more actions based on a number of the one or more actions that match the particular actions.

According to some possible implementations, the one or more computers, when determining the change score for the one or more changes, may quantify the one or more changes; and determine the change score based on quantifying the one or more changes.

According to some possible implementations, a computer storage medium may store instructions, where the instructions may include one or more instructions which, when executed by one or more processors, cause the one or more processors to: identify one or more actions performed by a user to satisfy an intent for information regarding an entity; determine a correlation score for the one or more actions, where the correlation score may indicate a level of correlation between the one or more actions and satisfying the intent for the information regarding the entity; determine that the correlation score satisfies a first threshold; obtain information identifying one or more changes associated with the entity; determine a change score for the one or more changes, where the change score may indicate a level of change that is associated with the entity; determine that the change score satisfies a second threshold; and provide the information identifying the one or more changes to the user based on the correlation score satisfying the first threshold and the change score satisfying the second threshold.

According to some possible implementations, one or more instructions, of the set of instructions, to provide the information to the user, when executed by the one or more processors, may cause the one or more processors to: provide one or more links at a client device associated with the user, where the one or more links may reference one or more applications from which the intent for the information regarding the entity can be satisfied, where the set of instructions, when executed by the one or more processors, may further cause the one or more processors to: receive a selection of one of the one or more links from the user; and cause, based on the selection of the one of the one or more links, the client device to execute one of the one or more applications, where the one of the one or more applications may permit the intent for the information regarding the entity to be satisfied.

According to some possible implementations, one or more instructions, of the set of instructions, to provide the information to the user, when executed by the one or more processors, may cause the one or more processors to: provide one or more links at a client device associated with the user, where the one or more links may reference one or more webpages from which the intent for the information regarding the entity can be satisfied, where the set of instructions, when executed by the one or more processors, may further cause the one or more processors to receive a selection of one of the one or more links from the user; and cause, based on the selection of the one of the one or more links, the client device to execute a web browser which displays a webpage of the one or more webpages, where the webpage may permit the intent for the information regarding the entity to be satisfied.

According to some possible implementations, the user is a first user, where one or more instructions, of the set of instructions, to determine the correlation score for the one or more actions, when executed by the one or more processors, may cause the one or more processors to: obtain data, where the data may identify a set of instances of a set of second users satisfying the intent for the information regarding the entity, where the data, which identifies a particular instance, of the set of instances, of a second user, of the set of second users, satisfying the intent for the information regarding the entity, may identify one or more candidate actions performed by the second user prior to the second user satisfying the intent for the information regarding the entity; and determine the correlation score for the one or more actions based on a number of the set of instances, identified by the data, of the second users performing the one or more actions.

According to some possible implementations, one or more instructions, of the set of instructions, to determine the correlation score for the one or more actions, when executed by the one or more processors, may cause the one or more processors to: match the one or more actions with particular actions relating to the intent for the information regarding the entity, where the particular actions may be associated with satisfying the intent for the information regarding the entity; and determine the correlation score for the one or more actions based on a number of the one or more actions that match the particular actions.

According to some possible implementations, one or more instructions, of the set of instructions, to determine the change score for the one or more changes, when executed by the one or more processors, may cause the one or more processors to quantify the one or more changes; and determine the change score based on quantifying the one or more changes.

According to some possible implementations, a system may include means for identifying one or more actions performed by a user to satisfy an intent for information regarding an entity; means for determining a correlation score for the one or more actions, where the correlation score may indicate a level of correlation between the one or more actions and satisfying the intent for the information regarding the entity; means for determining that the correlation score satisfies a first threshold; means for obtaining information describing one or more changes associated with the entity; means for determining a change score for the one or more changes, where the change score may indicate a level of change that is associated with the entity; means for determining that the change score satisfies a second threshold; and means for providing the information describing the one or more changes to the user based on the correlation score satisfying the first threshold and the change score satisfying the second threshold.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

FIG. 1 illustrates an example knowledge graph containing nodes and edges.

FIG. 2 illustrates an example knowledge graph portion.

FIG. 3 illustrates another example knowledge graph portion.

FIG. 4 illustrates another example knowledge graph portion.

FIG. 5 illustrates another example knowledge graph portion.

FIG. 6 illustrates an example information provider system.

FIG. 7 illustrates an example method for providing information based on intent.

FIGS. 8A-8B illustrate example graphical user interfaces for providing information based on intent.

Like reference numbers and designations in the various drawings indicate like elements.

### DETAILED DESCRIPTION

The subject matter described in this specification can be implemented in particular embodiments so as to realize one or more of the following advantages. Intent for entities can be determined from user actions. Information describing changes associated with the entities can be obtained based on determined intents for entities. The information can be provided.

In some implementations, data may be organized in a database using any one or more data structuring techniques. For example, data may be organized in a graph containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. The edge, and thus the graph, may be directed, i.e. unidirectional, undirected, i.e. bidirectional, or both, i.e. one or more edges may be undirected and one or more edges may be directional in the same graph. Nodes may include any suitable data or data representation. Edges may describe any suitable relationships between the data. In some implementations, an edge is labeled or annotated, such that the edge includes both the connection between the nodes, and descriptive information about that connection. A particular node may be connected by distinct edges to one or more other nodes, or to itself, such that an extended graph is formed. For purposes of clarity, a graph based on the structure described immediately above is referred to herein as a knowledge graph. In some implementations, the knowledge graph may be a useful for representing information and in providing information in search.

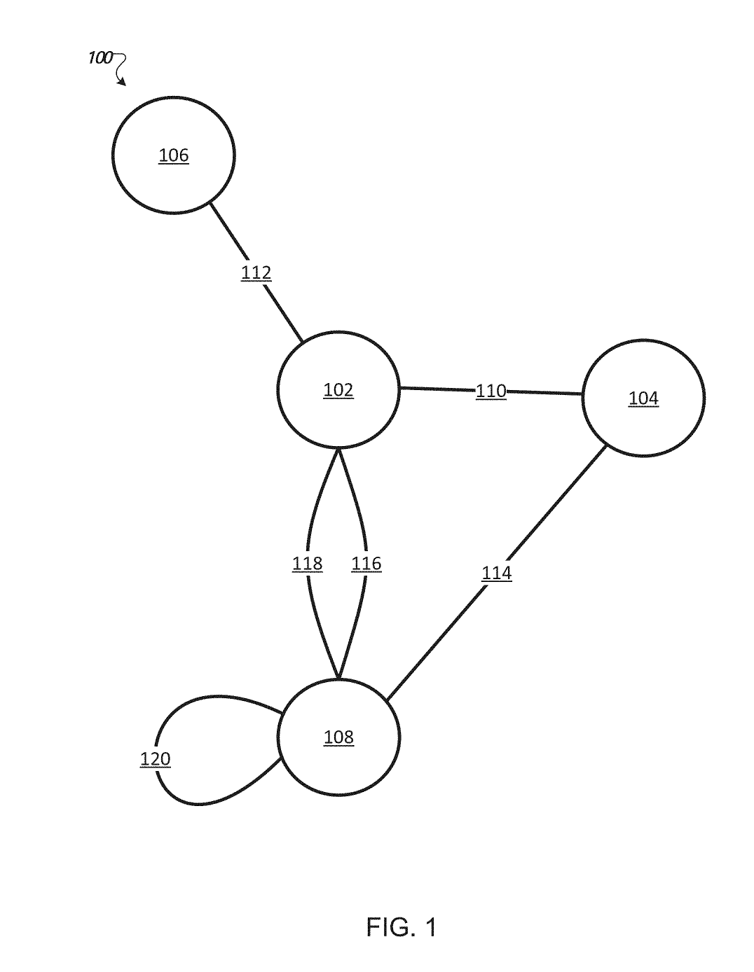

FIG. 1 illustrates an example knowledge graph 100 containing nodes and edges. Illustrative knowledge graph 100 includes nodes 102, 104, 106, and 108. Knowledge graph 100 includes edge 110 connecting node 102 and node 104. Knowledge graph 100 includes edge 112 connecting node 102 and node 106. Knowledge graph 100 includes edge 114 connecting node 104 and node 108. Knowledge graph 100 includes edge 116 and edge 118 connecting node 102 and node 108. Knowledge graph 100 includes edge 120 connecting node 108 to itself. Each aforementioned group of an edge and one or two distinct nodes may be referred to as a triple or 3-tuple. As illustrated, node 102 is directly connected by edges to three other nodes, while nodes 104 and 108 are directly connected by edges to two other nodes. Node 106 is connected by an edge to only one other node, and in some implementations, node 106 is referred to as a terminal node. As illustrated, nodes 102 and 108 are connected by two edges, indicating that the relationship between the nodes is defined by more than one property. As illustrated, node 108 is connected by edge 120 to itself, indicating that a node may relate to itself. While illustrative knowledge graph 100 contains edges that are not labeled as directional, it will be understood that each edge may be unidirectional or bidirectional. It will be understood that this example of a graph is merely an example and that any suitable size or arrangement of nodes and edges may be employed.

Generally, nodes in a knowledge graph can be grouped into several categories. Nodes may represent entities, organizational data such as entity types and properties, literal values, and models of relationships between other nodes.

In some implementations, entity types, properties, and other suitable content is created, defined, redefined, altered, or otherwise generated by any suitable technique. For example, content may be generated by manual user input, by automatic responses to user interactions, by importation of data from external sources, by any other suitable technique, or any combination thereof. For example, if a commonly searched for term is not represented in the knowledge graph, one or more nodes representing that node may be added. In another example, a user may manually add information and organizational structures.

A node of a knowledge graph may represent an entity. An entity is a thing or concept that is singular, unique, well-defined and distinguishable. For example, an entity may be a person, place, item, idea, abstract concept, concrete element, other suitable thing, or any combination thereof. Nodes are unique, in that no two nodes refer to the same thing or concept. Generally, entities include things or concepts represented linguistically by nouns. For example, the color “Blue,” the city “San Francisco,” and the imaginary animal “Unicorn” may each be entities. An entity generally refers to the concept of the entity. For example, the entity “New York City” refers to the physical city, and the knowledge graph uses a concept of the physical city as represented by, for example, an element in a data structure, the name of the entity, any other suitable element, or any combination thereof.

A node representing organizational data may be included in a knowledge graph. These may be referred to herein as entity type nodes. As used herein, an entity type node may refer to a node in a knowledge graph, while an entity type may refer to the concept represented by an entity type node. An entity type may be a defining characteristic of an entity. For example, entity type node Y may be connected to an entity node X by an “Is A” edge or link, discussed further below, such that the graph represents the information “The Entity X Is type Y.” For example, the entity node “George Washington” may be connected to the entity type node “President.” An entity node may be connected to multiple entity type nodes, for example, “George Washington” may also be connected to entity type node “Person” and to entity type node “Military Commander.” In another example, the entity type node “City” may be connected to entity nodes “New York City” and “San Francisco.” In another example, the concept “Tall People,” although incompletely defined, i.e., it does not necessarily include a definition of “tall,” may exist as an entity type node. In some implementations, the presence of the entity type node “Tall People,” and other entity type nodes, may be based on user interaction.

In some implementations, an entity type node may include or be connected to data about: a list of properties associated with that entity type node, the domain to which that entity type node belongs, descriptions, values, any other suitable information, or any combination thereof. A domain refers to a collection of related entity types. For example, the domain “Film” may include, for example, the entity types “Actor,” “Director,” “Filming Location,” “Movie,” any other suitable entity type, or any combination thereof. In some implementations, entities are associated with types in more than one domain. For example, the entity node “Benjamin Franklin” may be connected with the entity type node “Politician” in the domain “Government” as well as the entity type node “Inventor” in the domain “Business.”

In some implementations, properties associated with entity nodes or entity type nodes may also be represented as nodes. For example, nodes representing the property “Population” or “Location” may be connected to the entity type node “City.” The combination and/or arrangement of an entity type and its properties is referred to as a schema. In some implementations, schemas are stored in tables or other suitable data structures associated with an entity type node. In some implementations, the knowledge graph may be self-defining or bootstrapping, such that it includes particular nodes and edges that define the concept of nodes, edges, and the graph itself. For example, the knowledge graph may contain an entity node “Knowledge Graph” that is connected to property nodes that describe a knowledge graph's properties such as “Has Nodes” and “Has Edges.”

Specific values, in some implementations referred to as literals, may be associated with a particular entity in a terminal node by an edge defining the relationship. Literals may refer to values and/or strings of information. For example, literals may include dates, names, and/or numbers. In an example, the entity node “San Francisco” may be connected to a terminal node containing the literal “815,000” by an edge annotated with the property “Has Population.” In some implementations, terminal nodes may contain a reference or link to long text strings and other information stored in one or more documents external to the knowledge graph. In some implementations, literals are stored as nodes in the knowledge graph. In some implementations, literals are stored in the knowledge graph but are not assigned a unique identification reference as described below, and are not capable of being associated with multiple entities. In some implementations, literal type nodes may define a type of literal, for example “Date/Time,” “Number,” or “GPS Coordinates.”

In some implementations, the grouping of an edge and two nodes is referred to as a triple. The triple represents the relationship between the nodes, or in some implementations, between the node and itself. In some implementations, higher order relationships are modeled, such as quaternary and n-ary relationships, where n is an integer greater than 2. In some implementations, information modeling the relationship is stored in a node, which may be referred to as a mediator node. In an example, the information “Person X Donates Artifact Y To Museum Z” is stored in a mediator node connected to entity nodes X, Y, and Z, where each edge identifies the role of each respective connected entity node.

In some implementations, the knowledge graph may include information for differentiation and disambiguation of terms and/or entities. As used herein, differentiation refers to the many-to-one situation where multiple names are associated with a single entity. As used herein, disambiguation refers to the one-to-many situation where the same name is associated with multiple entities. In some implementations, nodes may be assigned a unique identification reference. In some implementations, the unique identification reference may be an alphanumeric string, a name, a number, a binary code, any other suitable identifier, or any combination thereof. The unique identification reference may allow the system to assign unique references to nodes with the same or similar textual identifiers. In some implementations, the unique identifiers and other techniques are used in differentiation, disambiguation, or both.

In some implementations of differentiation, a node may be associated with multiple terms or differentiation aliases in which the terms are associated with the same entity. For example, the terms “George Washington,” “Geo. Washington, “President Washington,” and “President George Washington” may all be associated with a single entity, i.e., node, in the knowledge graph. This may provide differentiation and simplification in the knowledge graph.

In some implementations of disambiguation, multiple nodes with the same or similar names are defined by their unique identification references, by associated nodes in the knowledge graph, by any other suitable information, or any combination thereof. For example, there may be an entity node related to the city “Philadelphia,” an entity node related to the movie “Philadelphia,” and an entity node related to the cream cheese brand “Philadelphia.” Each of these nodes may have a unique identification reference, stored for example as a number, for disambiguation within the knowledge graph. In some implementations, disambiguation in the knowledge graph is provided by the connections and relationships between multiple nodes. For example, the city “New York” may be disambiguated from the state “New York” because the city is connected to an entity type “City” and the state is connected to an entity type “State.” It will be understood that more complex relationships may also define and disambiguate nodes. For example, a node may be defined by associated types, by other entities connected to the node by particular properties, by its name, by any other suitable information, or any combination thereof. These connections may be useful in disambiguating, for example, the node “Georgia” that is connected to the node “United States” may be understood to represent the U.S. State, while the node “Georgia” connected to the nodes “Asia” and “Eastern Europe” may be understood to represent the country in eastern Europe.

In some implementations, a node may include or connect to data defining one or more attributes. The attributes may define a particular characteristic of the node. The particular attributes of a node may depend on what the node represents. In some implementations, an entity node may include or connect to: a unique identification reference, a list of entity types associated with the node, a list of differentiation aliases for the node, data associated with the entity, a textual description of the entity, links to a textual description of the entity, other suitable information, or any combination thereof. As described above, nodes may contain a reference or link to long text strings and other information stored in one or more documents external to the knowledge graph. In some implementations, the storage technique may depend on the particular information. For example, a unique identification reference may be stored within the node, a short information string may be stored in a terminal node as a literal, and a long description of an entity may be stored in an external document linked to by a reference in the knowledge graph.

An edge in a knowledge graph may represent a semantic connection defining a relationship between two nodes. The edge may represent a prepositional statement such as “Is A,” “Has A,” “Is Of A Type,” “Has Property,” “Has Value,” any other suitable statement, or any combination thereof. For example, the entity node of a particular person may be connected by a “Date Of Birth” edge to a terminal node containing a literal of his or her specific date of birth. In some implementations, the properties defined by edge connections of an entity may relate to nodes connected to the type of that entity. For example, the entity type node “Movie” may be connected to entity nodes “Actor” and “Director,” and a particular movie may be connected by an edge property “Has Actor” to an entity node representing a particular actor.

In some implementations, nodes and edges define the relationship between an entity type node and its properties, thus defining a schema. For example, an edge may connect an entity type node to a node associated with a property, which may be referred to as a property node. Entities of the type may be connected to nodes defining particular values of those properties. For example, the entity type node “Person” may be connected to property node “Date of Birth” and a node “Height.” Further, the node “Date of Birth” may be connected to the literal type node “Date/Time,” indicating that literals associated with “Date of Birth” include date/time information. The entity node “George Washington,” which is connected to entity type node “Person” by an “Is A” edge, may also be connected to a literal “Feb. 22, 1732” by the edge “Has Date Of Birth.” In some implementations, the entity node “George Washington” is connected to a “Date Of Birth” property node. It will be understood that in some implementations, both schema and data are modeled and stored in a knowledge graph using the same technique. In this way, both schema and data can be accessed by the same search techniques. In some implementations, schemas are stored in a separate table, graph, list, other data structure, or any combination thereof. It will also be understood that properties may be modeled by nodes, edges, literals, any other suitable data, or any combination thereof.

For example, the entity node “George Washington” may be connected by an “Is A” edge to the entity type node representing “Person,” thus indicating an entity type of the entity, and may also be connected to a literal “Feb. 22, 1732” by the edge “Has Date Of Birth,” thus defining a property of the entity. In this way, the knowledge graph defines both entity types and properties associated with a particular entity by connecting to other nodes. In some implementations, “Feb. 22, 1732” may be a node, such that it is connected to other events occurring on that date. In some implementations, the date may be further connected to a year node, a month node, and a day node. It will be understood that this information may be stored in any suitable combination of literals, nodes, terminal nodes, interconnected entities, any other suitable arrangement, or any combination thereof.

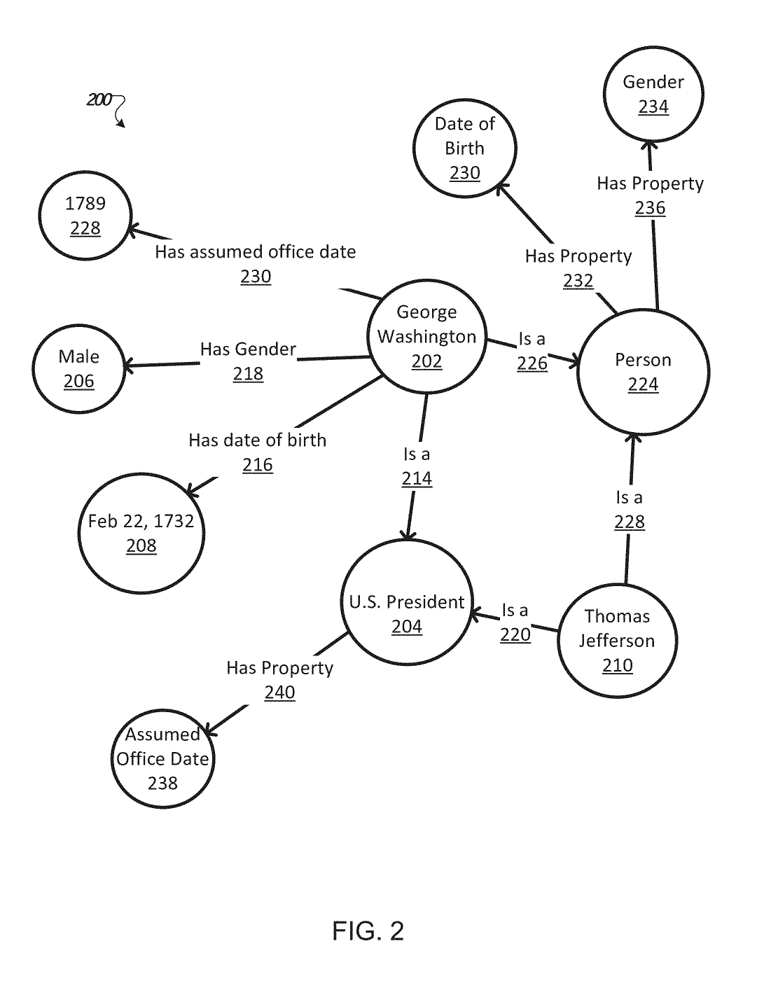

FIG. 2 illustrates an example knowledge graph portion 200. Knowledge graph portion 200 includes information related to the entity “George Washington,” represented by “George Washington” node 202. “George Washington” node 202 is connected to “U.S. President” entity type node 204 by “Is A” edge 214 with the semantic content “Is A,” such that the 3-tuple defined by nodes 202 and 204 and the edge 214 contains the information “George Washington is a U.S. President.” Similarly, the information “Thomas Jefferson Is A U.S. President” is represented by the tuple of “Thomas Jefferson” node 210, “Is A” edge 220, and “U.S. President” node 204. Knowledge graph portion 200 includes entity type nodes “Person” 224, and “U.S. President” node 204. The person type is defined in part by the connections from “Person” node 224. For example, the type “Person” is defined as having the property “Date Of Birth” by node 230 and edge 232, and is defined as having the property “Gender” by node 234 and edge 236. These relationships define in part a schema associated with the entity type “Person.”

“George Washington” node 202 is shown in knowledge graph portion 200 to be of the entity types “Person” and “U.S. President,” and thus is connected to nodes containing values associated with those types. For example, “George Washington” node 202 is connected by “Has Gender” edge 218 to “Male” node 206, thus indicating that “George Washington has gender “Male.” Further, “Male” node 206 may be connected to the “Gender” node 234 indicating that “Male Is A Type Of Gender.” Similarly, “George Washington” node 202 is be connected by “Has Date of Birth” edge 216 to “Feb. 22, 1732” node 208, thus indicating that “George Washington Has Date Of Birth Feb. 22, 1732.” “George Washington” node 202 may also be connected to “1789” node 228 by “Has Assumed Office Date” edge 230.

Knowledge graph portion 200 also includes “Thomas Jefferson” node 210, connected by “Is A” edge 220 to entity type “U.S. President” node 204 and by “Is A” edge 228 to “Person” entity type node 224. Thus, knowledge graph portion 200 indicates that “Thomas Jefferson” has the entity types “U.S. President” and “Person.” In some implementations, “Thomas Jefferson” node 210 is connected to nodes not shown in FIG. 2 referencing his date of birth, gender, and assumed office date.

It will be understood that knowledge graph portion 200 is merely an example and that it may include nodes and edges not shown. For example, “U.S. President” node 204 may be connected to all of the U.S. Presidents. “U.S. President” node 204 may also be connected to properties related to the entity type such as a duration of term, for example “4 Years,” a term limit, for example “2 Terms,” a location of office, for example “Washington D.C.,” any other suitable data, or any combination thereof. For example, “U.S. President” node 204 is connected to “Assumed Office Date” node 238 by “Has Property” edge 240, defining in part a schema for the type “U.S. President.” Similarly, “Thomas Jefferson” node 210 may be connected to any suitable number of nodes containing further information related to his illustrated entity type nodes “U.S. President,” and “Person,” and to other entity type nodes not shown such as “Inventor,” “Vice President,” and “Author.” In a further example, “Person” node 224 may be connected to all entities in the knowledge graph with the type “Person.” In a further example, “1789” node 228 may be connected to all events in the knowledge graph with the property of year “1789.” “1789” node 228 is unique to the year 1789, and disambiguated from, for example, a book entitled “1789,” not shown in FIG. 2, by its unique identification reference. In some implementations, “1789” node 228 is connected to the entity type node “Year.”

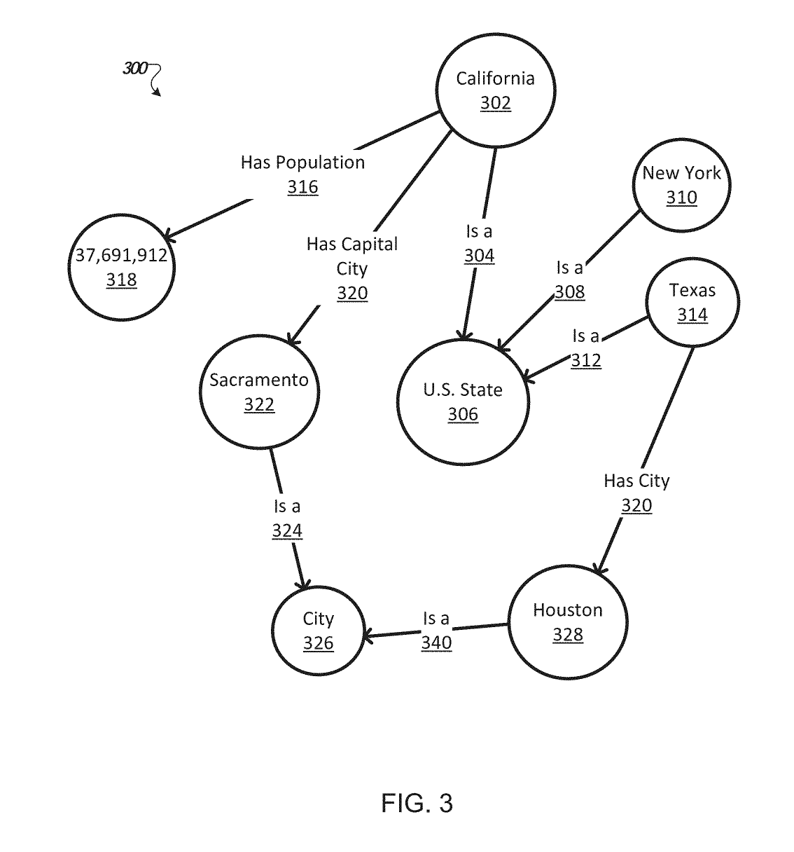

FIG. 3 illustrates another example knowledge graph portion 300. Knowledge graph portion 300 includes “California” node 302, which may also be associated with differentiation aliases such as, for example, “CA,” “Calif.,” “Golden State,” any other suitable differentiation aliases, or any combination thereof. In some implementations, these differentiations are stored in “California” node 302. California is connected by “Is A” edge 304 to the “U.S. State” entity type node 306. “New York” node 310 and “Texas” node 314 are also connected to “U.S. State” node 306 by “Is A” edges 308 and 312, respectively. “California” node 302 is connected by “Has Capital City” edge 320 to “Sacramento” node 322, indicating the information that “California Has Capital City Sacramento.” Sacramento node 322 is further connected by “Is A” edge 324 to the “City” entity type node 326. Similarly, “Texas” node 314 is connected by “Has City” edge 320 to “Houston” node 328, which is further connected to the “City” entity type node 326 by “Is A” edge 340. “California” node 302 is connected by “Has Population” edge 316 to node 318 containing the literal value “37,691,912.” In an example, the particular value “37,691,912” may be periodically automatically updated by the knowledge graph based on an external website or other source of data. Knowledge graph portion 300 may include other nodes not shown. For example, “U.S. State” entity type node 306 may be connected to nodes defining properties of that type such as “Population” and “Capital City.” These type—property relationships may be used to define other relationships in knowledge graph portion 300 such as “Has Copulation” edge 316 connecting entity node “California” 316 with terminal node 318 containing the literal defining the population of California.

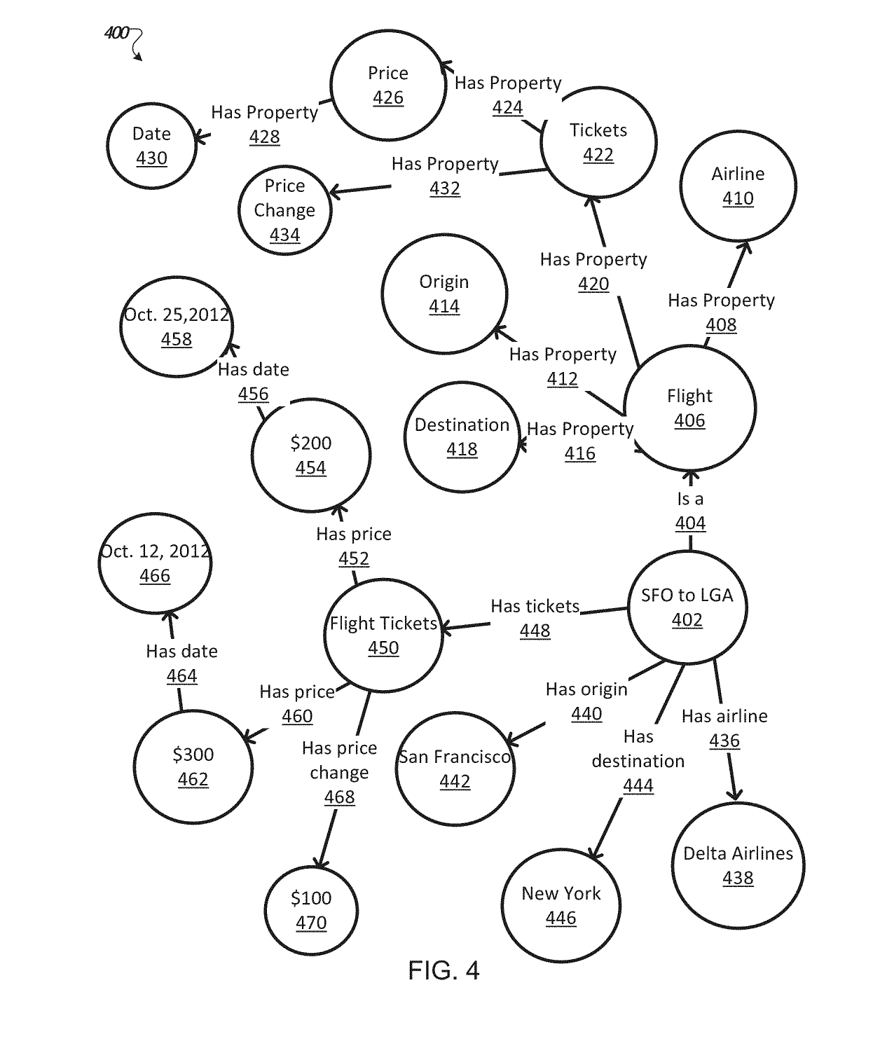

FIG. 4 illustrates another example knowledge graph portion 400. Knowledge graph portion 400 includes information related to the flight entity that originates from San Francisco International Airport, i.e., SFO, and terminates at LaGuardia Airport, i.e., LGA, represented by “SFO to LGA” node 402. The “SFO to LGA” node 402 is connected by “Is a” edge 404 to the “Flight” entity type node 406.

The entity type “Flight” is defined in part by the connections from “Flight” node 406. For example, the entity type “Flight” is defined as having the properties “Airline” by node 410 and edge 408, “Origin” by node 414 and edge 412, “Destination” by node 418 and edge 416, and “Tickets” by node 422 and edge 420. These relationships define in part a schema associated with the entity type “Flight.” Additionally, the property “Tickets” is defined as having the properties “Price” by node 426 and edge 424 and “Price Change” by node 434 and edge 432. The property “Price” is defined as having the property “Date” by node 430 and edge 428. These relationships define in part a schema associated with the entity type “Flight.”

“SFO to LGA” node 402 is shown in knowledge graph portion 400 to be of the entity type “Flight,” and thus is connected to nodes containing values associated with the entity type. For example, “SFO to LGA” node 402 is connected by “Has airline” edge 436 to “Delta Airlines” node 438. This indicates, “The SFO to LGA flight entity has airline Delta Airlines.” “SFO to LGA” node 402 is also connected by “Has origin” edge 440 to “San Francisco” node 442. This indicates, “The SFO to LGA flight entity has an origin of San Francisco.” “SFO to LGA” node 402 is also connected by “Has destination” edge 444 to “New York” node 446. This indicates, “The SFO to LGA flight entity has a destination of New York.”

The “SFO to LGA” node 402 is also connected by “Has tickets” edge 448 to “Flight Tickets” node 450. This indicates, “The SFO to LGA flight has flight tickets.” Furthermore, “Flight Tickets” node 450 is connected by “Has price” edge 452 to “$200” node 454. Furthermore, “$200” node 454 is connected by “Has date” edge 456 to “Oct. 25, 2012” node 458. Combining nodes 402, 450, 454, and 458 and edges 448, 452, and 456 indicates, “The SFO to LGA flight entity has tickets that have price of $200 on Oct. 25, 2012.” Furthermore, “Flight Tickets” node 450 is connected by “Has price” edge 460 to “$300” node 462. Furthermore, “$300” node 462 is connected by “Has date” edge 464 to “Oct. 12, 2012” node 466. Combining nodes 402, 450, 462, and 466 and edges 448, 460, and 464 indicates, “The SFO to LGA flight entity has tickets that have price of $300 on Oct. 12, 2012.” Furthermore, “Flight Tickets” node 450 is connected by “Has price change” edge 468 to “$100” node 470. Combining nodes 402, 450, and 470 and edges 448 and 468 indicates, “The SFO to LGA flight entity has tickets that have price change of $100.”

It will be understood that knowledge graph portion 400 is merely an example and that it may include nodes and edges not shown. For example, “Flight” node 406 may also be connected to other properties related to the entity type such as flight time, flight distance, departing terminal, arrival terminal, and any other suitable data, or any combination thereof. Similarly, “SFO to LGA” node 402 may be connected to any suitable number of nodes containing further information related to its illustrated entity type node “Flight.”

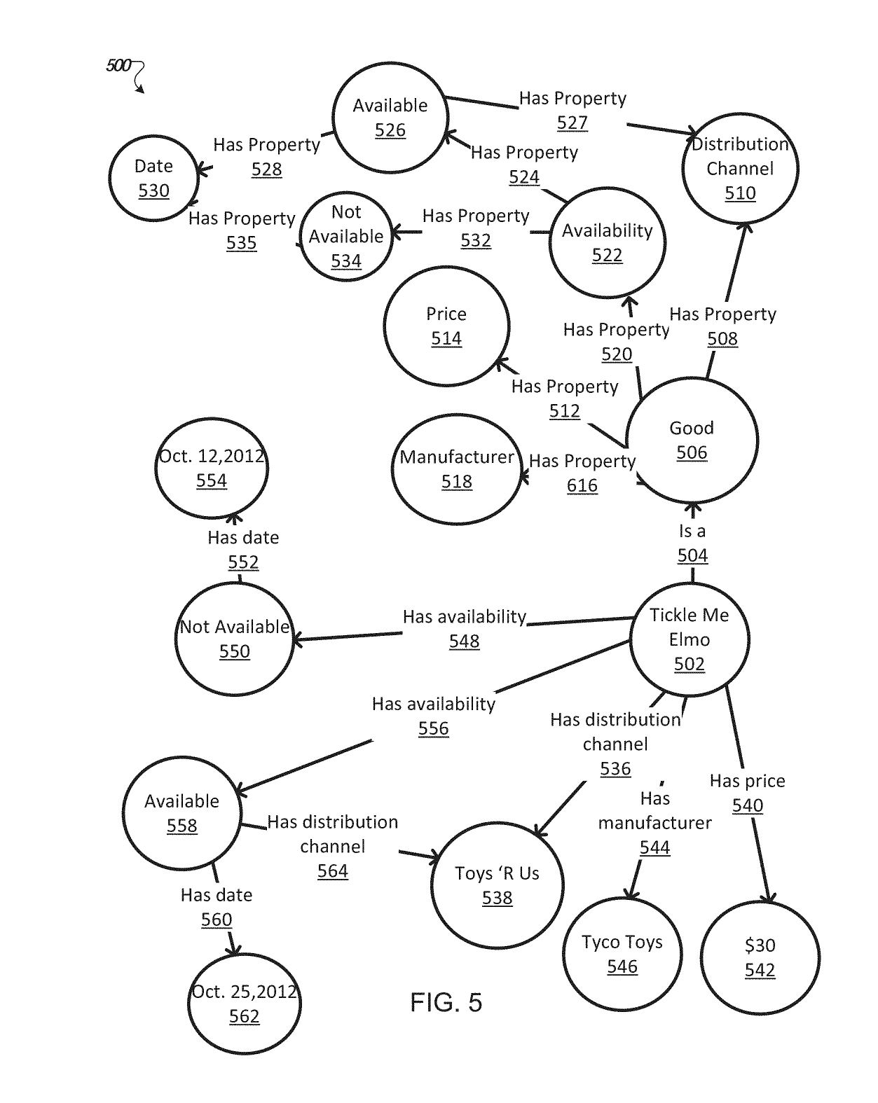

FIG. 5 illustrates another example knowledge graph portion 500. Knowledge graph portion 500 includes information related to the Tickle Me Elmo toy represented by “Tickle Me Elmo” node 502. The “Tickle Me Elmo” node 502 is connected by “Is a” edge 504 to the “Good” entity type node 506.

The entity type “Good” is defined in part by the connections from “ Good ” node 506. For example, the entity type “Good” is defined as having the properties “Distribution Channel” by node 510 and edge 508, “Price” by node 514 and edge 512, “Manufacturer” by node 518 and edge 516, and “Availability” by node 522 and edge 520. These relationships define in part a schema associated with the entity type “Good.” Additionally, the property “Availability” is defined as having the properties “Available” by node 526 and edge 524 and “Not Available” by node 534 and edge 532. The properties “Available” and “Not Available” are defined as having the property “Date” by node 530 and edges 528 and 535, respectively. The property “Availability” is additionally defined as having the property “Distribution Channel” by node 510 and edge 527. These relationships define in part a schema associated with the entity type “Good.”

“Tickle me Elmo” node 502 is shown in knowledge graph portion 500 to be of the entity type “Good,” and thus is connected to nodes containing values associated with the entity type. For example, “Tickle me Elmo” node 502 is connected by “Has distribution channel” edge 536 to “Toys 'R Us” node 538. This indicates, “The Tickle Me Elmo goods entity has distribution channel Toys 'R Us.” “Tickle me Elmo” node 502 is also connected by “Has price” edge 540 to “$30” node 542. This indicates, “The Tickle Me Elmo goods entity has a price of $30.” “Tickle me Elmo” node 502 is also connected by “Has manufacturer” edge 544 to “Tyco Toys” node 546. This indicates, “The Tickle Me Elmo goods entity has manufacturer Tyco Toys.”

The “Tickle me Elmo” node 502 is also connected by “Has availability” edge 548 to “Not Available” node 550. This indicates, “The Tickle Me Elmo goods entity is not available.” Furthermore, “Not Available” node 550 is connected by “Has date” edge 552 to “Oct. 12, 2012” node 554. Combining nodes 502, 550, and 554 and edges 548 and 552 indicates, “The Tickle Me Elmo goods entity is not available on Oct. 12, 2012.” The “Tickle me Elmo” node 502 is also connected by “Has availability” edge 556 to “Available” node 558. This indicates, “The Tickle Me Elmo goods entity is available.” Furthermore, “Available” node 558 is connected by “Has date” edge 560 to “Oct. 25, 2012” node 562. Combining nodes 502, 558, and 562 and edges 556 and 560 indicates, “The Tickle Me Elmo goods entity is available on Oct. 25, 2012.” Furthermore, “Available” node 558 is connected by “Has distribution channel” edge 564 to “Toys 'R Us” node 538. Combining nodes 502, 558, and 538 and edges 556 and 564 indicates, “The Tickle Me Elmo goods entity is available from Toys 'R Us.”

It will be understood that while knowledge graph portion 200 of FIG. 2, knowledge graph portion 300 of FIG. 3, knowledge graph portion 400 of FIG. 4, and knowledge graph portion 500 of FIG. 5 show portions of a knowledge graph, all pieces of information may be contained within a single graph and that these selections illustrated herein are merely an example. In some implementations, separate knowledge graphs are maintained for different respective domains, for different respective entity types, or according to any other suitable delimiting characteristic. In some implementations, separate knowledge graphs are maintained according to size constraints. In some implementations, a single knowledge graph is maintained for all entities and entity types.

A knowledge graph may be implemented using any suitable software constructs. In an example, a knowledge graph is implemented using object oriented constructs in which each node is an object with associated functions and variables. Edges, in this context, may be objects having associated functions and variables. In some implementations, data contained in a knowledge graph, pointed to by nodes of a knowledge graph, or both, is stored in any suitable one or more data repositories across one or more servers located in one or more geographic locations coupled by any suitable network architecture.

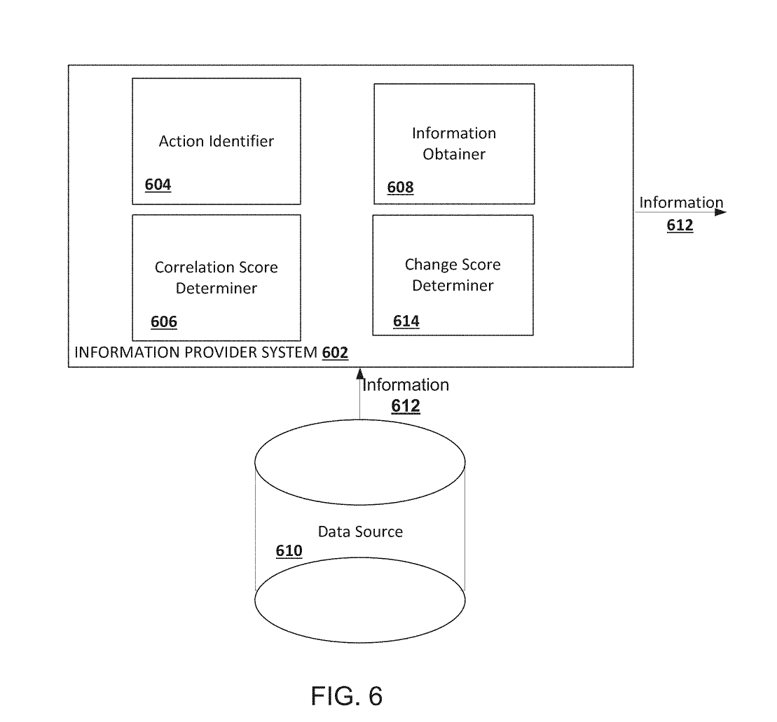

FIG. 6 illustrates an example information provider system 602 as can be implemented for use in an Internet, an intranet, or another client and server environment. The information provider system 602 can be implemented as, for example, computer programs running on one or more computers in one or more locations that are coupled to each other through a network. The systems, components, and techniques described below can be implemented in the example information provider system 602.

The information provider system 602 includes an action identifier 604, a correlation score determiner 606, an information obtainer 608, and a change score determiner 614. The information provider system 602 can communicate with a data source 610 through one or more wired or wireless networks, e.g., mobile phone networks, local area networks (LANs) or wide area networks (WANs), e.g., the Internet. In some implementations, data source 610 can be one or more data sources. For example, the information provider system 602 can communicate with one or more databases that contain data organized in the form of a knowledge graph, as described above. Alternatively, the entity provider system 602 can communicate with one or more data sources, including publicly available sources, e.g., the Internet Move Database (IMDB), Wikipedia, Ticketmaster, Freebase, and/or any other website.

The action identifier 604 identifies actions performed by users. The actions can be any act performed by users within web-based properties or applications. Web-based properties can include email clients, search engines, content providers, and web pages. A web-based application is any program or group of programs that can be run on a client device, e.g., a personal computer or mobile device. Web-based applications can include email programs, search engine programs, and any third-party application. The actions can be actions performed by users to interact with the web-based properties or applications. Examples of actions include receiving emails in an email client, accessing electronic documents on web pages, and performing searches at a search engine. The action identifier 604 can identify actions performed by users that are associated with the users attempts to satisfy intents for entities. The actions can be, for example, actions performed prior to the action performed that completes the satisfying of the intent for the entity. In some implementations, the identified actions can be explicit actions performed by users to satisfy intents for entities. A user can request from a web-based property or application information related to the entity for which the user would like to satisfy an intent. For example, if the user would like to purchase a trip to Las Vegas, the user can request information related to trips to Las Vegas. The web-based property or application can provide information related to trips to Las Vegas, such as airfare and hotel fare. In some implementations, the identified actions can be implicit actions performed by users to satisfy intents for entities. For example, the action identifier 604 can identify multiple actions performed by a user to satisfy the user's intent for an entity, e.g., purchasing a trip to Las Vegas. These actions can include the user performing searches for flights to Las Vegas and the user performing searches for hotels in Las Vegas on a travel-based website or application. As a further example, the action identifier 604 can identify actions that the user performs to satisfy the intent of purchasing of concert tickets. These actions can include the user performing a search for the concert on a search engine and performing a search for tickets for the concert on a website associated with a ticket distribution channel.

In some implementations, the action identifier 604 can identify and store the actions performed by users. For example, every action performed by a user in web-based properties and applications can be stored by the action identifier 604. Additional information can be identified and stored for each action. For example, the time and date that the action was performed, the user who performed the action, a description of the action, and the web-based property or application used to perform the action can be stored for each action. In some implementations, the action identifier 604 can identify the actions performed by users from one or more databases containing user data. The one or more databases can contain entries for users. Each entry is associated with a user and describes the actions performed by the user. In situations in which the systems discussed here collects user data, or may make use of user data, the users may be provided with an opportunity to control whether programs or features collect user information, or to control whether and/or how to receive content from the systems that may be more relevant to the user. Thus, the user may have control over how information is collected about the user and used by the systems.

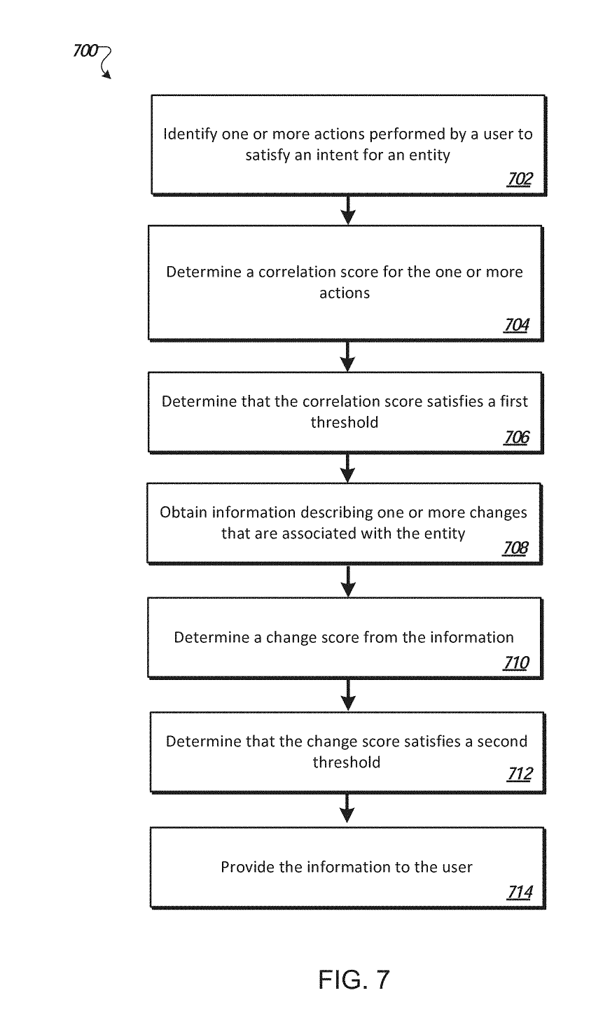

The correlation score determiner 606 determines a correlation score from the actions identified by the action identifier, as described in more detail below with reference to FIG. 7. The correlation score for the actions performed by a user indicates a level of correlation between the actions and the user satisfying the intent for the entity. After the correlation score is determined for the actions, the correlation score determiner 606 determines whether the correlation score satisfies a threshold.

The information obtainer 608 obtains information 612 associated with the entities for which users are performing actions to satisfy an intent, as described in more detail below with reference to FIG. 7. The information 612 can be obtained from one or more data sources 610, as described above. Example information that can be obtained includes costs for flight entities, costs for hotel entities, costs for trip entities, or any costs associated with an entity. In some implementations, the information can describe changes associated with entities. For example, the information can describe a change in costs for flights for fight entities, a change in hotel costs for hotel entities, change in availability for goods entities, etc.

The change score determiner 614 determines a change score from the information obtained by the information obtainer 608, as described in more detail below with reference to FIG. 7. The change score for the information 612 obtained by the information obtainer 608 indicates a level of change that is associated with entities. The change score determiner 614 determines whether to provide the information 612 from the change score determined by change score determiner 614.

The information provider system 602 provides the obtained information 612. The obtained information 602 is presented to users. In some implementations, the information 612 can be provided directly to users. For example, the information 612 can be sent directly to a user's client device. In other implementations, the information 612 can be provided to a notification system that makes additional determinations on when and whether to provide the information 612 to users.

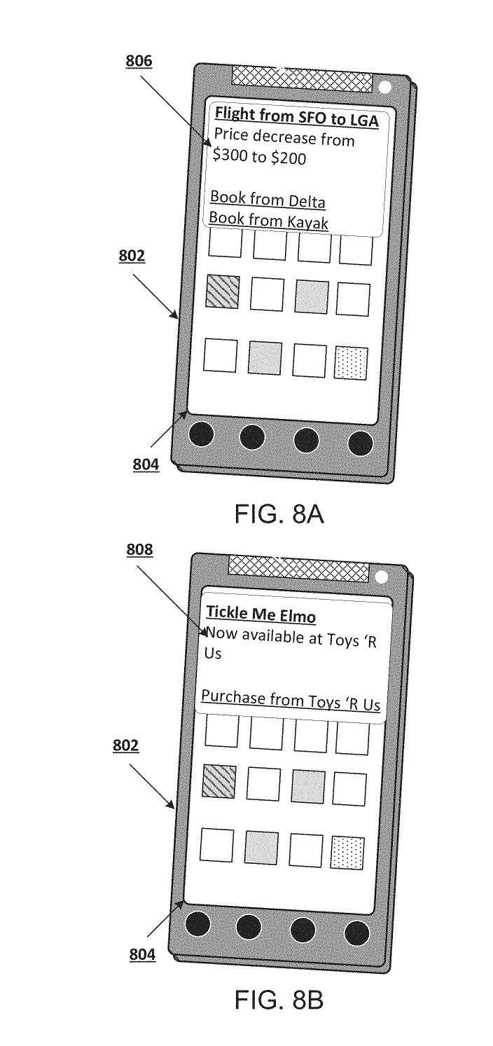

In some implementations, client devices can provide notifications to users about the information 612. For example, in response to receiving the information 612, client devices can generate visual notifications, e.g., the information 612 displayed on display screens associated with the client devices, and/or audible notifications, e.g., an audible representation of the information 612 generated by speakers associated with the client devices. Alternatively, or additionally, the information can be presented in the form of notification objects, as described in more detail below with reference to FIGS. 8A-8B. The notification objects can display text describing the entities and the information associated with the entities. A picture or icon that represents the information can also be displayed. Links can also be provided with the notification objects so users can take additional actions on the provided information. For example, if the user is provided with a notification object describing a decrease in price for a flight, the notification object can additionally provide a link from which the user can purchase tickets for the flight. As a further example, if the user is provided with a notification object describing an availability of tickets for a concert, the notification object can additionally provide a link from which the user can purchase the tickets.

FIG. 7 illustrates an example method for providing information based on intent. For convenience, the example method 700 will be described in reference to a system that performs method 700. The system can be, for example, the information provider system 602 described above with reference to FIG. 6. In some implementations, the system can be one or more computers.

The system identifies one or more actions performed by a user to satisfy an intent for an entity (702), as described above with reference to FIG. 6. In some implementations, the system identifies only those actions performed by the user to satisfy intents for entities. For example, if the user has performed a variety of actions, including actions to satisfy an intent to purchase tickets for a flight to Las Vegas, only those actions associated with satisfying the intent to purchase the flight tickets are identified. In some implementations, the system identifies all actions performed by the user, regardless of whether the actions were performed to satisfy the intent for the entity. For example, the system can identify a variety of actions performed by the user, including actions to satisfy an entity to purchase tickets for a flight to Las Vegas as well as actions that are associated with other intents of the user or actions that are not associated with any particular intent of the user. In some implementations, the system identifies actions performed by the user within a predetermined time frame. For example, the system only identifies actions performed by the user within the last week.

The system determines a correlation score for the one or more actions (704). In some implementations, the system determines the correlation score for the one or more actions based on data describing instances of users satisfying the intent for the entity. For example, the system can obtain data describing instances of users satisfying the intent for the entity. The data can describe the actions performed by users in web-based properties or applications for each instance of users satisfying intents for entities. A user satisfies an intent for an entity when the user completes an action that satisfies the user's intent for the entity. The data can additionally describe actions performed by the user prior to the user satisfying the intent for the entity. The data can describe other information for instances of users satisfying the intent for the entity. For example, the data can additionally describe a point in time associated with each action performed by the users. The point in time can include the date and time that the action was performed. From this data, a model can be generated for the intent for the entity. The one or more actions can be input into the model, which outputs the correlation score for the one or more actions.

In some implementations, the model determines a score for each of the actions of the one or more actions. The score for an action can be determined from the number of instances that the action has been performed, as described by the data. For example, the number of instances that the action has been performed can be used to weight the score for the action. Actions that have been performed several times as described by the data can be assigned greater scores than actions that have been performed fewer times. Additionally, or alternatively, the score for an action can be determined from time measurements that measure the amount of time between the points in time that the action is performed and the points in time that the intent for the entity is satisfied as described by the data. For example, for instances where users perform the action and subsequently satisfies the intent for the entity, the amount of time between when the action is performed and when the intent for the entity is satisfied can be determined. The amount of time for the different instances can be averaged. The resulting average can be used to weight the score for the action. Actions that are on average performed closer in time to when the intents for entities are satisfied can be assigned greater scores than actions that are on average performed further away in time. The correlation score for the one or more actions can then be calculated by combining the scores for each of the one or more actions according to a combination function, for example, the scores can be added or multiplied together.

In some implementations, the system determines the correlation score for the one or more actions based on predetermined actions for the intent for the entity. In some implementations, the predetermined actions are manually predetermined as actions that are associated with satisfying the intent for the entity. For example, one or more human curators can manually identify the predetermined actions. Specific predetermined actions can be defined for specific intents for entities. For example, for the intent to purchase flight tickets, the predetermined actions can include performing a search for terms that identify both the origin and destination city and performing a search for hotels in the destination city. The predetermined actions can be further defined by contexts in which the actions have to be performed. For example, the context for a predetermined action can specify a specific web-based property or application in which the action has to be performed. For example, the predetermined action of performing a search for hotels in the destination city can specify that the action has to be performed in a travel website or an application associated with the travel website.

The system matches the one or more identified actions with the predetermined actions for the intent for the entity. The correlation score for the one or more actions can be determined from the matching of the one or more actions with the predetermined actions. In some implementations, the correlation score can be determined from the number of identified actions that match the predetermined actions. For example, the correlation score can be determined from the proportion of identified actions that match the predetermined actions. In some implementations, the correlation score can be determined from the number of predetermined actions that match the identified actions. For example, the correlation score can be determined from the proportion of predetermined actions that match the identified actions. In some implementations, the predetermined actions can be individually weighted when determining the correlation score. Certain predetermined actions for an intent for an entity are stronger indicators for satisfying the intent for the entity. The predetermined actions that are stronger indicators for satisfying the intent for the entity are assigned greater weights when determining the correlation score for the one or more actions. For example, for the intent to purchase flight tickets, human curators can determine that the predetermined action of performing a search for terms that identify the origin and destination city is a stronger indicator for satisfying the intent than the predetermined action of performing a search for hotels in the destination city. Therefore, the action of performing a search for terms that identify the origin and destination city is assigned a greater correlation score than the action of performing a search for hotels in the destination city.

If the correlation score does not satisfy a first threshold, the system takes no further action on the identified actions performed by the user. In some implementations, the identified actions are stored. The actions can be stored for a predetermined amount of time. The system can identify additional actions performed by the user, and determine the correlation score from a combination of the additional actions and the stored actions. If the system determines that the correlation score satisfies the first threshold (706), the system obtains information describing one or more changes that are associated with the entity (708). In some implementations, in response to determining that the correlation score satisfies the first threshold, the entity is associated with the user as an entity of interest. The information obtained for the one or more changes can describe any change associated with the entity. A change associated with an entity is a change to an attribute of the entity. For example, a change in flight times or a change in cost of flight tickets can be changes associated with a flight entity. As a further example, a change in the availability of a good can be a change associated with a good entity. A good is anything that can satisfy a want or need of the user. A good can be tangible, e.g., a consumer product, or intangible, e.g., movies or songs in a digital medium. In some implementations, the information describing the changes is obtained from a knowledge graph portion containing the schema for the entity in a data source. Any information that is associated with the particular entity node in the knowledge graph portion can be obtained by the system. The system can obtain information represented by nodes associated with the entity node. Certain nodes can represent changes associated with the entity node. For example, the system can obtain information represented by a change node that describes a change in the cost associated with a flight entity. Alternatively, or additionally, the system can obtain information represented by multiple nodes that are associated with the entity node. The information represented by the multiple nodes can represent a change associated with the entity node. Each of the multiple nodes can represent an instance of a particular attribute for the entity represented by the entity node. For example, each of the multiple nodes can represent the cost for a flight entity at a particular point in time.

In some implementations, the system can obtain information that describes changes associated with the particular entity from other types of data sources. For example, information that describes changes associate with goods entities can be directly obtained from publicly available sources, e.g., retail websites. From these sources, the system can directly obtain information describing changes in pricing or availability of goods. As a further example, information describing changes associated with flight entities can be obtained directly from travel websites, e.g., Kayak or Travelocity, or websites associated with the airlines that operate the flights. From these sources, the system can directly obtain information that describes changes in pricing, availability, and flight times for flights.

In some implementations, the system can compare information obtained for an entity to generate information that describes changes associated with the entity. For example, the system can obtain current information associated with the entity in addition to past information associated with the entity obtained at past points in time. The system can then generate information that describes the current information relative to the past information. For example, the system can obtain information describing the current price for a particular flight entity. From this information, the system can generate information describing a change in the price for the flight entity by describing the current price for the flight entity in comparison to past price information for the flight entity obtained at a prior date.

The system determines a change score from the information (710). The system quantifies the changes associated with the entity as described by the information. In some implementations, the changes described by the information are represented by integer values. For example, the information can describe that the current cost for a flight entity is $200 compared to $300 a week prior. In some implementations, the changes described by the information are not represented by integer values. For example, the information can describe that a good, e.g., a consumer product, is now currently available for purchase from distribution channels, whereas the good was previous unavailable for purchase. A binary numeral system can be used to assign integer values to the two different states of the entity described by the information. For example, the system can assign a 0 to the entity state of being unavailable for purchase and assign a 1 to the entity state of now currently available for purchase. The change score can be calculated by combining the two integer values according to a combination function, for example, one of the integer values can be subtracted from the other integer value. Alternatively, the change score can be calculated by taking a ratio of the two integer values.

If the change score does not satisfy a second threshold, the system takes no further action on the identified actions performed by the user. In some implementations, different second thresholds can be set for different intents for entities. For example, the second threshold for the intent to purchase tickets for a particular flight entity can be different than the second threshold for the intent to purchase a good entity. In some implementations, there can be different second thresholds for a specific intent for an entity. The second threshold can be specific for the type of change information obtained by the system. For example, the second threshold for the intent to purchase a good entity when the change information describes a change in the price of the good can be different than the threshold for when the information describes a change in the availability of the good.

If the system determines that the change score satisfies the second threshold (712), the system provides the information to the user (714), as described above with reference to FIG. 6. The information is provided to the user so that the user is notified about the change associated with the entity that is described by the information. In some implementations, the system provides one or more links with the information. The one or more links can reference webpages or applications that were the original source of the information. Alternatively, or additionally, the one or more links can reference webpages or applications from which the user can satisfy the intent for the entity. In some implementations, the system provides the links to the user by presenting the links in a graphical user interface on a display screen of the user's client device. The graphical user interface can include a notification object. The notification object presents the information to the user. The notification object includes text describing the entity identifier, text describing the information, and the links to the webpages or applications. The system can receive an interaction with a presented link at the client device from the user. In some implementations, in response to the received interaction, the system opens a web browser on the user's client device. The system then sends a webpage referenced by the link to the web browser, which is displayed to the user by the web browser. The user can satisfy his or her intent for the entity from the webpage. In some implementations, in response to the received interaction, the system causes the user's client device to run an application referenced by the link. The user can satisfy his or her intent for the entity from the application.

FIG. 8A-8B illustrate example graphical user interfaces for providing information based on intent.

In FIG. 8A, a system, for example the information provider system 602 described above with reference to FIG. 6, can identify actions performed by a user to satisfy an intent to purchase tickets for the flight entity from San Francisco to New York. For example, the system can identify that the user has performed the actions of performing a search in a search engine for the terms “Flight,” “SFO,” and “LGA,” as well as performed a search in a travel search website for a hotel in New York. The system determines a correlation score for the identified actions, as described above with reference to FIG. 7. For example, the system can match the identified actions with predetermined actions for the intent to purchase a flight from San Francisco to New York. The correlation score can be determined from this matching. The system determines that the threshold score satisfies a first threshold. In response to determining that the threshold score satisfies the first threshold, the system obtains information that describes changes associated with the entity. For example, the system can access a knowledge graph portion in a data source containing a schema for flight entity “SFO to LGA” to obtain information associated with “SFO to LGA,” for example, knowledge graph portion 400 illustrated in FIG. 4. From knowledge graph portion 400, the system can obtain information describing that flight tickets associated with entity “SFO to LGA” has a price change of $100. The system can also obtain information that today's, Oct. 25^{th}, price for flight tickets is $200, whereas the price was $300 on Oct. 12^{th}. From this information, the system determines a change score, a described above with reference to FIG. 6. For example, the system quantifies the price decrease of $100 in ticket prices for the flight entity.

The system determines that the change score satisfies a second threshold, and provides the user with the information describing the change. The system causes a graphical user interface 806 to be presented on a display screen 804 on the user's client device 802. The graphical user interface 806 includes a notification object. The notification object presents information describing the entity that the user would like to satisfy an intent for, information describing the change associated with the entity, and one or more links from which the user can take additional actions on the provided information. For example, the notification object includes text describing the flight entity, e.g., “Flight from SFO to LGA,” text describing the change associated with the flight entity, e.g., “Price decrease from $300 to $200,” and links from the which the user can purchase tickets for the flight entity. In this example, the links reference Delta and Kayak as sources from where the user can purchase tickets for the flight entity. The links “Book from Delta” and “Book from Kayak” are anchor text that links the user directly to the Delta and Kayak websites, respectively, from which the user can purchase tickets for the flight entity. Alternatively, interactions with the anchor text links can cause the client device to run an application referenced by the link. The user can purchase tickets for the flight entity from the application.

In FIG. 8B, a system, for example the information provider system 602 described above with reference to FIG. 6, can identify actions performed by a user to satisfy an intent to purchase the Tickle Me Elmo goods entity. For example, the system can identify that the user has performed the actions of performing a search in a search engine for the query “Tickle Me Elmo,” as well as performed a search in a commerce website for the query “Tickle Me Elmo.” The system determines a correlation score for the identified actions, as described above with reference to FIG. 7. For example, a model can be generated for the intent to purchase Tickle Me Elmo from data describing instances of users satisfying their intent to purchase Tickle Me Elmo. The user's actions are input into the model, which outputs the correlation score. The system determines that the threshold score satisfies a first threshold. In response to determining that the threshold score satisfies the first threshold, the system obtains information that describes changes associated with the entity. For example, the system can access a knowledge graph portion in a data source containing a schema for the good entity “Tickle Me Elmo” to obtain information associated with “Tickle Me Elmo,” for example, knowledge graph portion 500 illustrated in FIG. 5. From knowledge graph portion 500, the system can obtain information describing that on today's date, Oct. 25^{th}, the Tickle Me Elmo is available for purchase from Toys 'R Us, whereas it was unavailable for purchase on Oct. 12^{th}. From this information, the system determines a change score, a described above with reference to FIG. 6. For example, the system assigns two different values to today's available state of the Tickle Me Elmo and the Oct. 12^{th} unavailable state of the Tickle Me Elmo. The change score can be determined from a combination function of the two values.

The system determines that the change score satisfies a second threshold, and provides the user with the information describing the change. The system causes a graphical user interface 808 to be presented on a display screen 804 on the user's client device 802. The graphical user interface 808 can include a notification object. The notification object presents information describing the entity that the user would like to satisfy an intent for, information describing the change associated with the entity, and one or more links from which the user can take additional actions on the provided information. For example, the notification object includes text describing the goods entity, e.g., “Tickle Me Elmo,” text describing the change associated with the goods entity, e.g., “Now available at Toys 'R Us,” and links from the which the user can purchase the goods entity. In this example, the links references Toys 'R Us as the source from where the user can purchase Tickle Me Elmo. The link “Purchase from Toys 'R Us” is anchor text that links the user directly to the Toys 'R Us website, from which the user can purchase Tickle Me Elmo. Alternatively, interactions with the anchor text link can cause the client device to run an application referenced by the link. The user can purchase the Tickle Me Elmo from the application.

An electronic document, which for brevity will simply be referred to as a document, may, but need not, correspond to a file. A document may be stored in a portion of a file that holds other documents, in a single file dedicated to the document in question, or in multiple coordinated files.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of the implementations or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

No element, act, or instruction used in the present application should be construed as critical or essential to the disclosed implementations unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

1. A computer-implemented method, comprising:
identifying actions performed by a user to satisfy an intent for information regarding an entity, the actions including one or more implicit actions;
determining a correlation score for the actions,
the correlation score indicating a level of correlation between the actions and satisfying the intent for the information regarding the entity, and determining the correlation score being based on a quantity of the actions performed by the user to satisfy the intent for the information regarding the entity;
determining that the correlation score satisfies a first threshold;
obtaining information describing one or more entity changes to one or more of a cost or an availability associated with the entity;
determining, based on the information, a change score for the one or more entity changes associated with the entity,
the change score indicating a level of change to the one or more of the cost or the availability that is associated with the entity;
determining that the change score satisfies a second threshold; and
based on the correlation score satisfying the first threshold and based on the change score satisfying the second threshold:
providing, for presentation at a client device associated with the user, a notification that describes the entity and that describes the level of change to the one or more of the cost or the availability associated with the entity.

2. The method of claim 1, where providing the notification further comprises:
providing one or more links at the client device associated with the user,
the one or more links referencing one or more applications from which the intent for the information regarding the entity can be satisfied, and where the method further comprises:
receiving a selection of one of the one or more links from the user; and
causing, based on the selection of the one of the one or more links, the client device to execute one of the one or more applications,
the one of the one or more applications permitting the intent for the information regarding the entity to be satisfied.

3. The method of claim 1, where providing the notification further comprises:
providing one or more links at the client device associated with the user,
the one or more links referencing one or more webpages from which the intent for the information regarding the entity can be satisfied, and where the method further comprising:
receiving a selection of one of the one or more links from the user; and
causing, based on the selection of the one of the one or more links, the client device to execute a web browser which displays a webpage of the one or more webpages,
the webpage permitting the intent for the information regarding the entity to be satisfied.

4. The method of claim 1, where the user is a first user, and
where determining the correlation score for the one or more actions comprises:
obtaining data,
the data identifying a plurality of instances of a plurality of second users satisfying the intent for the information regarding the entity, and
the data, which identifies a particular instance, of the plurality of instances, of a second user, of the plurality of second users, satisfying the intent for the information regarding the entity, identifying one or more candidate actions performed by the second user prior to the second user satisfying the intent for the information regarding the entity; and
determining the correlation score for the one or more actions from the data identifying the plurality of instances of the plurality of second users performing the one or more actions.

5. The method of claim 4, where determining the correlation score for the one or more actions comprises:
determining the correlation score based on a number of the plurality of instances, identified by the data, of the second users performing the one or more actions.

6. (canceled)

7. The method of claim 1, where determining the change score for the one or more changes comprises:
quantifying the one or more changes; and
determining the change score based on quantifying the one or more changes.

8. A system, comprising:
one or more computers, implemented at least partially in hardware, to:
identify actions performed by a user to satisfy an intent for information regarding an entity, the actions including one or more implicit actions;
determine a correlation score for the actions,
the correlation score indicating a level of correlation between the actions and satisfying the intent for the information regarding the entity, and determining the correlation score being based on a quantity of the actions performed by the user to satisfy the intent for the information regarding the entity;
determine that the correlation score satisfies a first threshold;
obtain information identifying one or more entity changes to one or more of a cost or an availability associated with the entity;
determine, based on the information, a change score for the one or more entity changes associated with the entity,
the change score indicating a level of change to the one or more of the cost or the availability that is associated with the entity that is associated with the entity;
determine that the change score satisfies a second threshold; and
based on the correlation score satisfying the first threshold and based on the change score satisfying the second threshold:
provide, for presentation at a client device associated with the user, a notification that describes the entity and that describes the level of change to the one or more of the cost or the availability associated with the entity.

9. The system of claim 8, where the one or more computers, when providing the notification, are further to:
provide one or more links at the client device associated with the user,
the one or more links referencing one or more applications from which the intent for the information regarding the entity can be satisfied, and
where the one or more computers are further to:
receive a selection of one of the one or more links from the user; and
cause, based on the selection of the one of the one or more links, the client device to execute one of the one or more applications,
the one of the one or more applications permitting the intent for the information regarding the entity to be satisfied.

10. The system of claim 8, where the one or more computers, when providing the notification, are further to:
provide one or more links at the client device associated with the user,
the one or more links referencing one or more webpages from which the intent for the information regarding the entity can be satisfied, and
where the one or more computers are further to:
receive a selection of one of the one or more links from the user; and
cause, based on the selection of the one of the one or more links, the client device to execute a web browser which displays a webpage of the one or more webpages,
the webpage permitting the intent for the information regarding the entity to be satisfied.

11. The system of claim 8, where the user is a first user,
where the one or more computers, when determining the correlation score for the one or more actions, are to:
obtain data,
the data identifying a plurality of instances of a plurality of second users satisfying the intent for the information regarding the entity, and
the data, which identifies a particular instance, of the plurality of instances, of a second user, of the plurality of second users, satisfying the intent for the information regarding the entity, identifying one or more candidate actions performed by the second user prior to the second user satisfying the intent for the information regarding the entity; and
determine the correlation score for the one or more actions based on the data identifying the plurality of instances of the plurality of second users performing the one or more actions.

12. The system of claim 11, where the one or more computers, when determining the correlation score, are to:
determine the correlation score based on a number of the plurality of instances, identified by the data, of the second users performing the one or more actions.

13. (canceled)

14. The system of claim 8, where the one or more computers, when determining the change score for the one or more changes, are to:
quantify the one or more changes; and
determine the change score based on quantifying the one or more changes.

15. A non-transitory computer storage medium storing instructions, the instructions comprising:
a plurality of instructions which, when executed by one or more processors, cause the one or more processors to:
identify actions performed by a user to satisfy an intent for information regarding an entity, the actions including one or more implicit actions;
determine a correlation score for the actions,
the correlation score indicating a level of correlation between the actions and satisfying the intent for the information regarding the entity;
determine that the correlation score satisfies a first threshold;
obtain information identifying one or more entity changes to one or more of a cost or an availability associated with the entity;
determine, based on the information, a change score for the one or more entity changes associated with the entity,
the change score indicating a level of change to the one or more of the cost or the availability that is associated with the entity that is associated with the entity;
determine that the change score satisfies a second threshold; and
based on the correlation score satisfying the first threshold and based on the change score satisfying the second threshold:
provide, for presentation at a client device associated with the user, a describing a notification that describes the entity and that describes the level of change to the one or more of the cost or the availability associated with the entity.

16. The non-transitory computer storage medium of claim 15, where one or more instructions, of the plurality of instructions, to provide the notification, when executed by the one or more processors, further cause the one or more processors to:
provide one or more links at the client device associated with the user,
the one or more links referencing one or more applications from which the intent for the information regarding the entity can be satisfied, and
where the plurality of instructions, when executed by the one or more processors, further cause the one or more processors to:
receive a selection of one of the one or more links from the user; and
cause, based on the selection of the one of the one or more links, the client device to execute one of the one or more applications,
the one of the one or more applications permitting the intent for the information regarding the entity to be satisfied.

17-20. (canceled)

21. The method of claim 1, wherein the change score indicates the level of change to the cost that is associated with the entity, where the level of change to the cost is based on comparison of a current price associated with the entity to a past price associated with the entity, the past price obtained at a prior date.

22. The method of claim 1, wherein the change score indicates the level of change to the availability that is associated with the entity, where the level of change to the availability is based on comparison of a current availability associated with the entity to a past availability associated with the entity, the past availability obtained at a prior date.

23. (canceled)

24. The method of claim 1, wherein the information describes the one or more of the cost or the availability for a prior time and the one or more of the cost or the availability for a current time, and wherein determining the change score is based on comparison of:
the one or more of the cost or the availability for the prior time, and
the one or more of the cost or availability for the current time.

25. The method of claim 1, wherein the notification describes the level of change by describing the one or more of the cost or the availability for a prior time and the one or more of the cost or the availability for a current time.

26. The method of claim 1, wherein the notification is an audible notification.

27. The method of claim 1, further comprising:
determining when to present the notification;
wherein providing, for presentation at the client device associated with the user, the notification, is based on determining when to present the notification.
